(19) United States
(12) Patent Application Publication
(10) Pub. No.: US 2010/0199119 A1
(43) Pub. Date: Aug. 5, 2010

(54) COMPUTER SYSTEM AND METHOD FOR OVERCLOCKING THE SAME

(75) Inventor: Pei-Hua Sun, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/698,160

(22) Filed: Feb. 2, 2010

(30) Foreign Application Priority Data
Feb. 2, 2009 (TW) 98103197

(51) Int. Cl. G06F 1/06

(52) U.S. Cl. 713/500; 713/600

(57) ABSTRACT

A computer system includes a clock generator, a system chipset, a controller and a multiplexing unit. The clock generator generates a reference clock according to a plurality of setting values in a frequency setting table. The system chipset generates a piece of first clock control information and a first clock. The controller is used to switch the level of the control signal and generates a piece of second clock control information and a second clock. The multiplexing unit is used to receive the control signal to select either the first clock control information or the second clock control information to be a piece of main clock control information and select either the first clock or the second clock to be a main clock. The clock generator adjusts the setting values according to the main clock control information and the main clock to change the frequency of the reference clock.

### CROSS-REFERENCE TO RELATED APPLICATION

This application claims the priority benefit of Taiwan application serial no. 98103197, filed on Feb. 2, 2009. The entirety of the above-mentioned patent application is hereby incorporated by reference herein and made a part of specification.

### BACKGROUND OF THE INVENTION

1. Field of the Invention

The invention relates to a computer system and a method for overclocking the same and, more particularly, to a computer system which may perform the overclocking by hardware control or software setting manner and a method for overclocking the same.

2. Description of the Related Art

The computer system usually has a clock generator to provide different operating clocks for a central processing unit (CPU) on a motherboard. When setting the operating clock of the CPU, the user usually increases the frequency of the operating clock of the CPU to a value higher than a preset value set by the manufacturer to save the expense, which is the so-called overclocking to improve the processing speed of the CPU.

In the prior art, there are several kinds of overclocking methods. In the earliest overclocking method, the user has to disassemble the case of the computer system and adjust a jump wire on the motherboard to change the frequency of the clock of the computer system. However, the user may feel inconvenient in this manner, and when disassembling the case and adjusting the motherboard, the user would possible incidentally damage other elements.

With the maturation of the semiconductor technique, most jump wires in the motherboard are replaced by electronic switches. Nowadays, the overclocking of the computer system may be performed via software setting. In detail, manners to overclock the computer system in the software setting may include overclocking in the BIOS setting mode or overclocking under the operating system (OS) dynamically.

However, regardless of overclocking in the BIOS setting mode or under the OS by executing applications, the overclocking performed via the software setting are mostly too complex to use, since the overclocking process requires a series of operation settings.

### BRIEF SUMMARY OF THE INVENTION

The invention discloses a computer system using a multiplexing unit to switch the control authority of the clock generator between the system chipset and the controller to the clock generator to adjust the processing speed of the CPU using hardware control or software setting manner.

The invention provides a method for overclocking a computer system which may overclock a computer system by hardware control or software setting manner. With using the hardware control manner, the tedious setting steps in the software setting process are avoided.

The invention provides a computer system including a clock generator, a system chipset, a controller and a multiplexing unit. The clock generator generates a reference clock according to a plurality of setting values in the frequency setting table. The system chipset is used to generate a piece of first clock control information and a first clock. The controller is used to switch the level of the control signal and generates a piece of second clock control information and a second clock. The multiplexing unit is used to receive the control signal to select either the first clock control information or the second clock control information to be a piece of main clock control information and select either the first clock or the second clock to be a main clock. further, the clock generator adjusts settings according to the main clock control information and the main clock to change a frequency of the reference clock.

In an embodiment of the invention, the computer system further includes a user interface. The user interface is electrically connected to the controller and generates an operating signal. In another aspect, when the controller detects the operating signal, the controller then switches a level of the control signal, and then generates the second clock control information and the second clock according to subsequently detected operating signal.

In an embodiment of the invention, the user interface includes a knob, and the operating signal is adjusted in the user interface according to a rotation of the knob.

In an embodiment of the invention, the user interface includes a plurality of keys, and the operating signal is set in the user interface according to pressing of the keys.

In an embodiment of the invention, the computer system further includes a CPU, the CPU is used to receive the reference clock and multiply the frequency of the reference clock to generate an operating clock.

In another aspect, the invention provides a method for overclocking a computer system. The method includes the steps as follows. First, providing a reference clock according to a plurality of setting values in a frequency setting table, associated with a piece of first clock control information and a first clock. Second, switching a level of the control signal and providing a piece of second clock control information and a second clock. Third, selecting either the first clock control information or the second clock control information to be a piece of main clock control information, and selecting either the first clock or the second clock to be a main clock. Therewith, the setting values are adjusted according to the main clock control information and the main clock, so as to change the frequency of the reference clock.

Based on the above, in the invention, the multiplexing unit is used to switch the control authority of the clock generator between the system chipset and the controller to perform overclocking by the software setting manner or the hardware control manner. Furthermore, besides providing multiple overclocking manners, the invention also simplifies overclocking procedure and dispense with tedious setting steps. Thus, the user may operate the computer system more conveniently.

### BRIEF DESCRIPTION OF THE DRAWINGS

FIG. 1 is a block diagram showing a circuit of the computer system in an embodiment of the invention; and

FIG. 2 is a flow chart showing the method for overclocking the computer system in an embodiment of the invention.

### DETAILED DESCRIPTION OF THE EMBODIMENTS

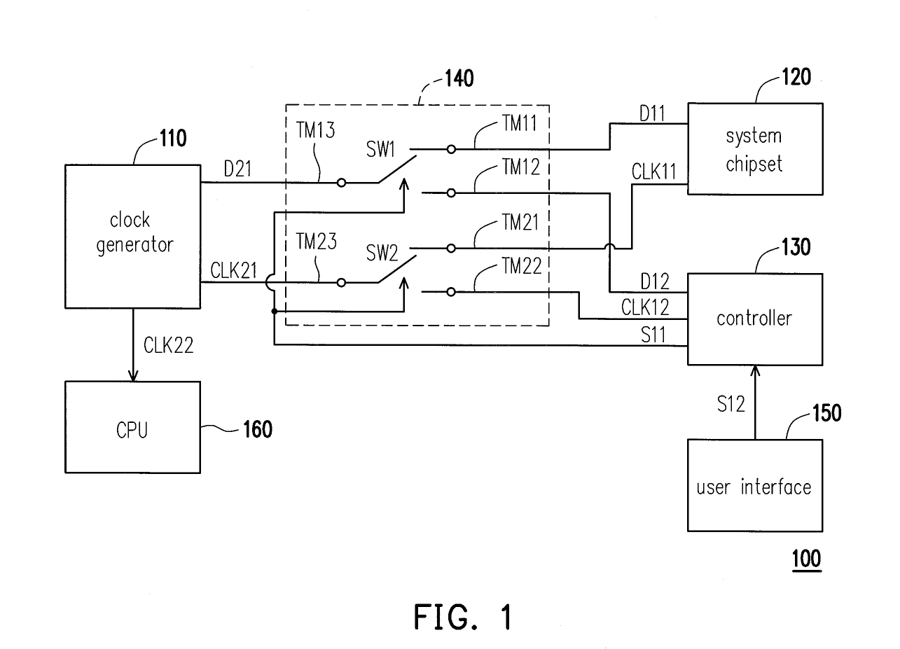

FIG. 1 is a block diagram showing a circuit of a computer system in an embodiment of the invention. As shown in FIG. 1, the computer system 100 includes a clock generator 110, a system chipset 120, a controller 130, a multiplexing unit 140, a user interface 150 and a CPU 160.

In the whole operation, the clock generator 110 generates a reference clock CLK 22 according to a plurality of setting values in a frequency setting table. In another aspect, the CPU 160 receives the reference clock CLK 22 and multiplies the frequency of the reference clock CLK 22 to generate an operating clock. In other words, the computer system 100 may change the operating clock of the CPU 160 via change the reference clock CLK 22. Therewith, the processing speed of the CPU 160 is adjusted.

For setting the reference clock CLK 22, the clock generator 110 adjusts a plurality of setting values in the frequency setting table according to a main clock CLK 21 and a piece of main clock control information D21. Accordingly, as the setting values are reset, the frequency of the reference clock CLK 22 generated by the clock generator 110 is changed therewith.

It is noticed, the control authority of the clock generator 110 is switched between the system chipset 120 and the controller 130 by the multiplexing unit 140. Thus, the main clock CLK 21 and the main clock control information D21 received by the clock generator 110 may be provided either by the system chipset 120 or the controller 130. To make a skilled person in the art further understand the embodiment, detail illustration about the control authority of the clock generator 110 described as follow.

As shown in FIG. 1, the system chipset 120 may be a southbridge chip, or any chips or elements which may generate a clock and a piece of clock control information. The system chipset 120 is used to generate a piece of first clock control information D11 and a first clock CLK11 which may transmit to the multiplexing unit 140 via a system management bus (SM Bus). In addition, the controller 130 may be an embedded controller, and it is used to switch the level of a control signal S11 and generate a piece of second clock control information D12 and a second clock CLK12. The second clock control information D12 and the second clock CLK12 of the controller 130 may also transmit to the multiplexing unit 140 via the SM Bus. Further, the control signal S11 may be output via a general purpose input output (GIPO) pin.

In another aspect, in the present embodiment, the multiplexing unit 140 includes a switch SW1 and a switch SW2, and the first terminal TM11 of the switch SW1 is electrically connected to the system chipset 120 to receive the first clock control information D11. The second terminal TM12 of the switch SW1 is electrically connected to the controller 130 to receive the second clock control information D12. The third terminal TM13 of the switch SW1 is electrically connected to the clock generator 110. In addition, the first terminal TM21 of the switch SW2 is electrically connected to the system chipset 120 to receive the first clock CLK11. The second terminal TM22 of the switch SW2 is electrically connected to the controller 130 to receive the second clock CLK12. The third terminal TM23 of the switch SW2 is electrically connected to the clock generator 110.

In the whole operation, the switch SW1 and the switch SW2 control the communicating state of each terminal according to the control signal S11 generated by the controller 130. For example, table 1 is a table showing source of the main clock CLK21 and the main clock control information D21.

TABLE 1

| | S11 = 0 | S11 = 1 |
|---|---|---|
| D21 | D11 | D12 |
| CLK21 | CLK11 | CLK12 |

As shown in table 1, when the level of the control signal S11 is switched to the logical zero, the third terminal TM13 and the first terminal TM11 of the switch SW1 communicate with each other to allow the first clock control information D11 transmitted to the clock generator 110 and determined as the main clock control information D21. In addition, the third terminal TM23 and the first terminal TM21 of the switch SW2 communicate with each other to allow the first clock CLK11 transmitted to the clock generator 110 and determined as the main clock CLK21. In other words, the clock generator 110 is controlled by the system chipset 120. Thus, the user may change the frequency of the reference clock CLK22 via the software setting overclocking mode in the BIOS or under the OS, and then the processing speed of the CPU 160 is adjusted.

In another aspect, when the level of the control signal S11 is switched to logical one, the third terminal TM13 of the switch SW1 and the second terminal TM12 communicate with each other, and the second clock control information D12 is transmitted to the clock generator 110 and determined as the main clock control information D21. In addition, the third terminal TM23 and the second terminal TM22 of the switch SW2 communicate with each other to allow the second clock CLK21 transmitted to the clock generator 110 and determined as the main clock CLK21. In other words, the clock generator 110 is controlled by the controller 130.

Notely, in the present embodiment, the user interface 150 is electrically connected to the controller 130 for controllably generating an operating signal S12. Thus, the controller 130 determines the generated control signal S11, the second clock CLK12 and the second clock control information D12 according to the generated operating signal S12.

For example, in the embodiment, the control priority of the controller 130 for controlling the clock generator 110 is set to be 1st, and thus once the controller 130 detects an operating signal S12, it switches the level of the control signal S11 to logical one to make the clock generator 110 controlled by the controller 130. Then, the controller 130 may generate the second clock control information D12 and the second clock CLK12 according to the detected operating signal S12.

Moreover, the user interface 150 in the embodiment includes a plurality of operating members which may be knobs or keys. When the user interface 150 includes a knob as the operating member, the user may directly rotate the knob to set the operating signal S12 to control the clock generator 110 via the controller 130. In other words, when the user wants to adjust the processing speed of the CPU 160, the user may first rotate the knob of the user interface 150 clockwise or counterclockwise to switch the control authority of the clock generator 110 to the controller 130.

Afterwards, when the knob in the user interface 150 is rotated counterclockwise, the controller 130 may transmit the corresponding second clock control information D12 and the second clock CLK12 to decrease the frequency of the second clock CLK 22. On the contrary, when the knob of the user interface 50 is rotated clockwise, the controller 130 may transmit corresponding second clock control information D12 and the second clock CLK12 to increase the frequency of the reference clock CLK22.

In another aspect, when operating member of the user interface 150 is a key, the user may presses the keys to set the operating signal S12 and to control the clock generator 110 via the controller 130. For example, the user interface 150 may include two frequency-control keys for increasing and decreasing the frequency. When the user wants to adjust the processing speed of the CPU 160, he or she may press one of the two frequency-control keys to switch the control authority of the clock generator 110 to the controller 130 at first. Then, the user may press one of the two frequency-control keys to make the controller 130 generate the corresponding second clock control information D12 and the second clock CLK12 to change the frequency of the reference clock CLK22.

In other words, when the clock generator 110 is controlled by the controller 130, the user may directly adjust the processing speed of the CPU 160 by controlling the operating member (such as the knob or the keys) in the user interface 150. With such, tedious setting procedure in the software is avoided, and the processing speed of the CPU 160 is adjusted in a hardware control overclocking mode.

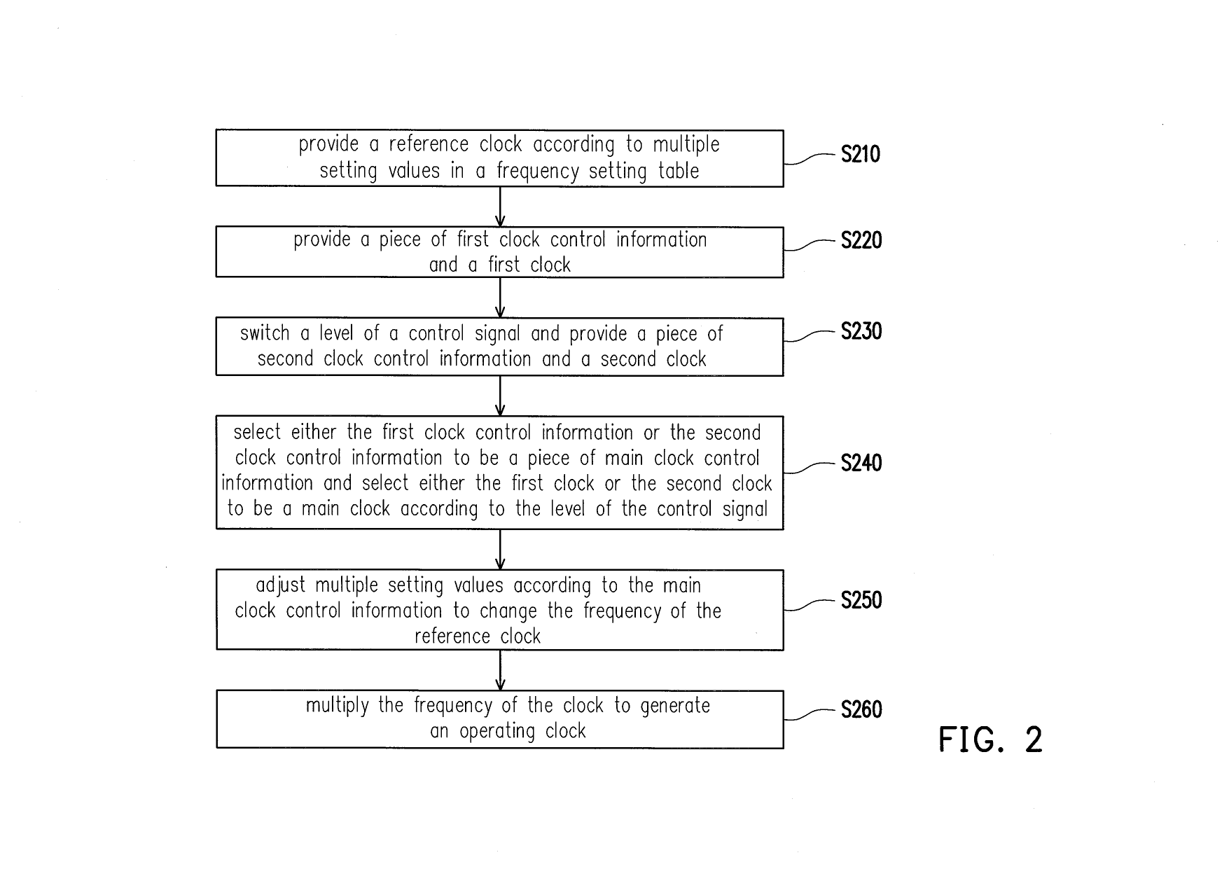

FIG. 2 is a flow chart showing the method for overclocking the computer system in an embodiment of the invention. As shown in FIG. 2, firstly, in step S210, providing a reference clock according to a plurality of setting values in a frequency setting table. In step S220, providing a piece of first clock control information and a first clock. Then, in step S230, switching the level of a control signal and providing a piece of second clock control information and a second clock.

Thus, in step S240, selecting either the first clock control information or the second clock control information to be a piece of main clock control information according to the level of the control signal, and then selecting either the first clock or the second clock to be the main clock. Thus, in the overclocking method of the invention, via the step S250, the setting values are adjusted according to the main clock control information and the main clock to change the frequency of the reference clock. Eventually, in step S260, multiplying the frequency of the reference clock to generate an operating clock. The detailed flow path of the overclocking method is included in the embodiment, and it is not illustrated herein.

To sum up, in the present invention, a multiplexing unit is used to switch the control authority of the clock generator between the system chipset and the controller. When the clock generator is controlled by the system chipset, the user may adjust the processing speed of the CPU in the software setting overclocking mode. In another aspect, when the clock generator is controlled by the controller, the user may adjust the processing speed of the CPU in the hardware control overclocking mode via the operating members (such as the knob or keys) in the user interface. Thus, tedious setting procedure according with prior art is avoided.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer system comprising:
a clock generator for generating a reference clock according to a plurality of setting values in a frequency setting table;
a system chipset for generating a piece of first clock control information and a first clock;
a controller for switching a level of a control signal and generating a piece of second clock control information and a second clock; and
a multiplexing unit to receive the control signal for selecting and outputting either the first clock control information or the second clock control information to be a piece of main clock control information, and selecting and outputting either the first clock or the second clock to be a main clock;
wherein the clock generator further adjusts the setting values according to the main clock control information and the main clock to change the frequency of the reference clock.

2. The computer system according to claim 1, further comprising:
a user interface electrically connected to the controller and generating an operating signal;
wherein when the controller detects the operating signal, the controller switches the level of the control signal and then generates the second clock control information and the second clock according to a subsequently detected operating signal.

3. The computer system according to claim 2, wherein the user interface comprises a knob, and the operating signal is adjusted in the user interface according to a rotation of the knob.

4. The computer system according to claim 2, wherein the user interface comprises a plurality of keys, and the operating signal is adjusted in the user interface according to pressing of the keys.

5. The computer system according to claim 1, further comprising:
a central processing unit (CPU) for receiving the reference clock and multiplying the frequency of the reference clock to generate an operating clock.

6. The computer system according to claim 1, wherein the multiplexing unit comprises:
a first switch having a first terminal for receiving the first clock control information, a second terminal for receiving the second clock control information and a third terminal electrically connected to the clock generator, wherein the first switch makes the third terminal of the first switch communicate with the first terminal or the second terminal of the first switch according to the control signal; and
a second switch having a first terminal for receiving the first clock, a second terminal for receiving the second clock and a third terminal electrically connected to the clock generator, wherein the second switch makes the third terminal of the second switch communicate with the first terminal or the second terminal of the second switch according to the control signal.

7. The computer system according to claim 1, wherein the first clock control information and the first clock are transmitted to the multiplexing unit via a system management bus (SM Bus).

8. The computer system according to claim 1, wherein the second clock control information and the second clock are transmitted to the multiplexing unit via a system management bus (SM Bus); and the control signal is outputted via a general purpose input output (GIPO) pin.

9. The computer system according to claim 1, wherein the system chipset is a southbridge chip.

10. The computer system according to claim 1, wherein the controller is an embedded controller.

11. A method for overclocking a computer system, comprising:
providing a reference clock according to a plurality of setting values in a frequency setting table;
providing a piece of first clock control information and a first clock;
switching a level of a control signal and providing a piece of second clock control information and a second clock;
selecting either the first clock control information or the second clock control information to be a piece of main clock control information, and selecting either the first clock or the second clock to be a main clock, according to the level of the control signal; and
adjusting the setting values according to the main clock control information and the main clock to change the frequency of the reference clock.

12. The method for overclocking the computer system according to claim 11, wherein the step of switching the level of the control signal and providing the second clock control information and the second clock comprises:
providing an operating signal via a user interface; and
switching the level of the control signal and providing the second clock control information and the second clock according to a subsequently detected operating signal when the operating signal is detected.

13. The method for overclocking the computer system according to claim 11, further comprising:
multiplying the frequency of the reference clock to generate an operating clock.
